(19) United States
(12) Patent Application Publication
(10) Pub. No.: US 2012/0159187 A1
(43) Pub. Date: Jun. 21, 2012

(54) ELECTRONIC DEVICE AND METHOD FOR PROTECTING AGAINST DIFFERENTIAL POWER ANALYSIS ATTACK

(75) Inventors: Po-Chun LIU, Taichung City (TW); Hsie-Chia CHANG, HsinChu (TW); Chen-Yi LEE, Hsinchu City (TW)

(73) Assignee: NATIONAL CHIAO TUNG UNIVERSITY, Hsinchu City (TW)

(21) Appl. No.: 13/034,713

(22) Filed: Feb. 25, 2011

(30) Foreign Application Priority Data
Dec. 15, 2010 (TW) 099144013

(51) Int. Cl. G06F 12/14

(52) U.S. Cl. 713/189

(57) ABSTRACT

An electronic device and a method for protecting against a differential power analysis attack are disclosed herein. The electronic device includes an encryption/decryption unit, a random number generator and a countermeasure circuit. The encryption/decryption unit can provide an enable signal when encrypting or decrypting more bits of data. The random number generator can generate random data. When receiving the enable signal, the countermeasure circuit can operate according to the bits of data and the random data.

### RELATED APPLICATIONS

This application claims priority to Taiwan Application Serial Number 099144013, filed Dec. 15, 2010, which is herein incorporated by reference.

### BACKGROUND

1. Technical Field

The present disclosure relates to a method and a device, and more particularly, a resisting method for differential power analysis (DPA) and an electronic device.

2. Description of Related Art

Encryption/decryption algorithms are widely used in wireless communication systems such as wireless area network, near field communication, data storage systems and bank systems. In 1999, Kocher et al. introduced differential power analysis that can efficiently and cost-effectively compromise an encryption/decryption chip; hence there is a need for providing countermeasure methods to protect an encryption/decryption chip from differential power analysis attacks.

The differential power analysis attack is to collect numerous power traces of different encryptions or decryptions. These traces can be analyzed by statistic calculations to find the possible key used by cryptographic devices.

In view of the foregoing, there is an urgent need in the related field to provide a way to protect against the differential power analysis attack.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to an electronic device and a method for protecting against a differential power analysis attack.

According to one embodiment of the present invention, the electronic device comprises an encryption/decryption unit, a random number generator, and a differential power analysis countermeasure circuit. The random number generator is electrically coupled to the encryption/decryption unit, and the differential power analysis countermeasure circuit is electrically coupled to the random number generator and the encryption/decryption unit. The encryption/decryption unit provides an enable signal when encrypting or decrypting a plurality of bits of data, and the random number generator generates random data. The differential power analysis countermeasure circuit operates according to the bits of data and the random data when receiving the enable signal.

In addition, the encryption/decryption unit stops providing the enable signal when not encrypting or decrypting the bits of data, so that the differential power analysis countermeasure circuit turns off.

The differential power analysis countermeasure circuit comprises a plurality of ring oscillators. The ring oscillators all receive the random data, wherein each of the ring oscillators receives one bit or combination of several bits of data.

Each of the ring oscillators comprises an XOR gate, a first NAND gate, at least one inverter, and a second NAND gate. A first input of the XOR gate is configured to receive one bit or the combination of several bits of data, and the other input of the XOR gate is configured to receive the random data. An input of the first NAND gate is connected to an output of the XOR gate, and an input of the at least one inverter is connected to an output of the first NAND gate. An input of the second NAND gate is connected to an output of the at least one inverter, the other input of the second NAND gate is configured to receive the enable signal, and an output of the second NAND gate is connected to the other input of the first NAND gate.

For example, the number of inverters is an odd number.

The electronic device may comprise a data register and an input/output buffer. The data register is electrically coupled to the encryption/decryption unit, and the input/output buffer is electrically coupled to the data register.

The encryption/decryption unit, the random number generator, the differential power analysis countermeasure circuit, the input/output buffer and the data register are all integrated into a single chip.

According to another embodiment of the present invention, the method for resisting differential power analysis comprises the steps as follows. An enable signal is generated when encrypting or decrypting a plurality of bits of data, random data are generated, and a differential power analysis countermeasure circuit is activated by the enable signal so that the differential power analysis countermeasure circuit operates according to the bits of data and the random data.

In addition, providing the enable signal is stopped when not encrypting or decrypting so that the differential power analysis countermeasure circuit turns off.

In conclusion, compared with the related art, the present invention has several advantages. Using the present invention can lead to great advance, be widely used in industry and has at least the following characteristics:
1. By dynamically changing power consumption characteristics of electronic devices during calculation, the dependency between power consumption of electronic devices and power models of attacks is reduced to resist a differential power analysis attack;
2. The differential power analysis countermeasure circuit works in parallel with the encryption/decryption unit so that the performance of the encryption/decryption unit can be not affected adversely; and
3. The enable signal functions as an activating control, so that the differential power analysis countermeasure circuit can turn off for power saving when electronic devices don't need protection.

### BRIEF DESCRIPTION OF THE DRAWINGS

The invention can be more fully understood by reading the following detailed description of the embodiments, with reference made to the accompanying drawings as follows:

FIG. 1 is a block diagram of an electronic device according to one embodiment of the present invention;

FIG. 2 is a block diagram of a differential power analysis countermeasure circuit of FIG. 1

FIG. 3 is procedures of a differential power analysis attack of one embodiment of the present invention;

FIG. 4 is an analysis result of not resisting a differential power analysis attack; and

FIG. 5 is an analysis result of resisting a differential power analysis attack by the method of the present invention.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In one or more various aspects, the present disclosure is directed to an electronic device that can resist a differential power analysis attack efficiently or be widely used in similar art.

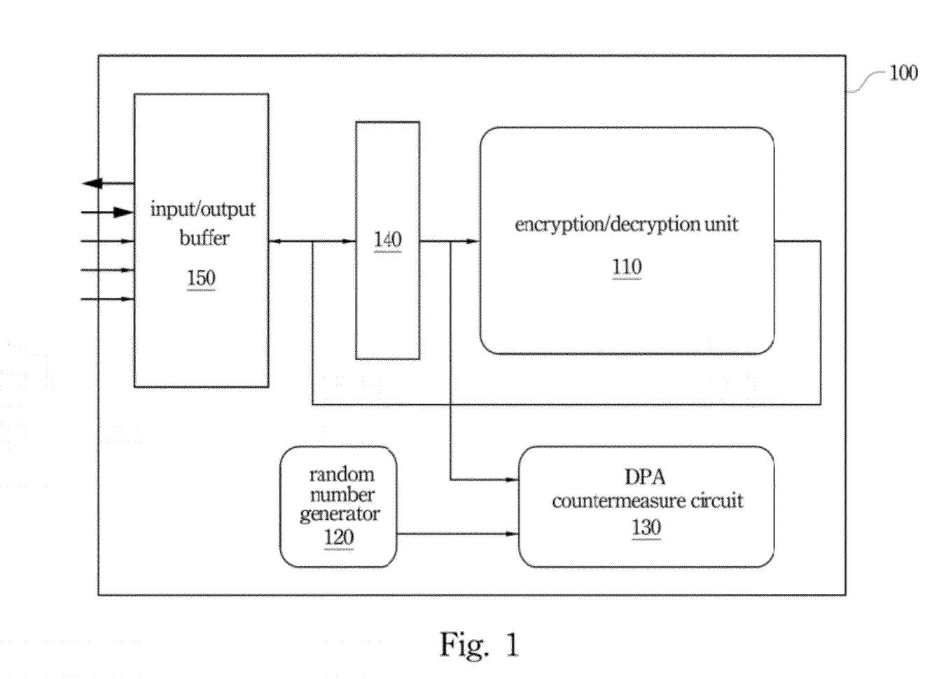

FIG. 1 is a block diagram of an electronic device 100 according to one embodiment of the present invention. As shown in FIG. 1, the electronic device 100 includes an encryption/decryption unit 110, a random number generator 120, and a differential power analysis countermeasure circuit 130.

The random number generator 120 is electrically coupled to the encryption/decryption unit 110. The differential power analysis countermeasure circuit 130 is electrically coupled to the random number generator 120 and the encryption/decryption unit 110.

The encryption/decryption unit 110 provides an enable signal when encrypting or decrypting a plurality of bits of data, and the random number generator 120 generates random data. When receiving the enable signal, the differential power analysis countermeasure circuit 130 operates according to the bits of data and the random data when receiving the enable signal, so as to dynamically change power consumption characteristics of the electronic device 100, thereby the dependency between power consumption of electronic devices and power models of attacks is reduced to resist a differential power analysis attack. The differential power analysis countermeasure circuit 130 works in parallel with the encryption/decryption unit 110 so that the performance of the encryption/decryption unit 110 can be not affected adversely.

In addition, the encryption/decryption unit 110 stops providing the enable signal when not encrypting or decrypting the bits of data, so that the differential power analysis countermeasure circuit 130 turns off. Therefore, the differential power analysis countermeasure circuit 130 turns off for power saving when the electronic device 100 doesn't need protection.

The electronic device 100 may comprise a data register 140 and an input/output buffer 150. The data register 140 is electrically coupled to the encryption/decryption unit 110, and the input/output buffer 150 is electrically coupled to the data register 140. The bits of data may be sent to the data register 140 by the input/output buffer 150, and the encryption/decryption unit 110 and the differential power analysis countermeasure circuit 130 may get data from the data register 140. Encrypting/decrypting data through the encryption/decryption unit 110 may also output through the input/output buffer 150.

The encryption/decryption unit 110, the random number generator 120, the differential power analysis countermeasure circuit 130, the data register 140 and the input/output buffer 150 are all integrated into a single chip, that means the electronic device 100 may be a single chip so that attackers are hard to extract encryption/decryption secret key of cryptographic chips by a differential power analysis attack.

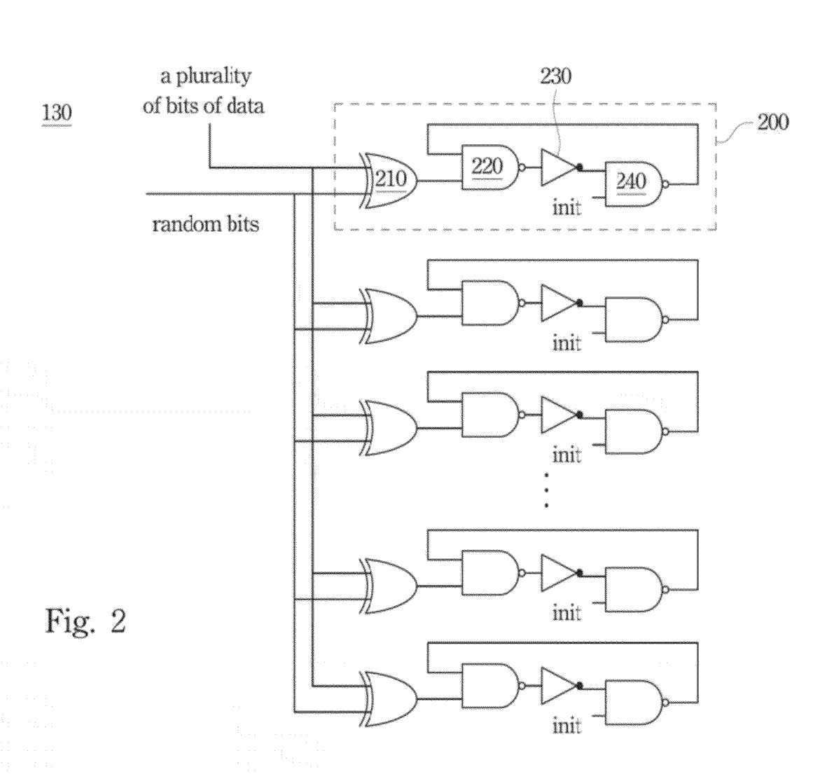

In practice, the encryption/decryption unit 110 may be a data processing circuit, a data processing module or similar device. Those with ordinary skill in the art may flexibly configure an encryption/decryption unit depending on the desired application. The structure of the differential power analysis countermeasure circuit 130 is shown in FIG. 2 that is a block diagram of the differential power analysis countermeasure circuit 130 according to one embodiment of the present invention.

As shown in FIG. 2, the differential power analysis countermeasure circuit 130 comprises a plurality of ring oscillators 200. The ring oscillators 200 all receive the random data, wherein each of the ring oscillators 200 receives one bit or combination of several bits of data. The differential power analysis countermeasure circuit 130 cooperates with the random data generated by the random number generator 120 to dynamically change the operation of the ring oscillators 200, so as to change power consumption characteristics of the electronic device 100.

Each of the ring oscillators 200 comprises: an XOR gate 210, a first NAND gate 220, an inverter 230, and a second NAND gate 240. A first input of the XOR gate 210 is configured to receive the one bit or the combination of several bits of data, and the other input of the XOR gate 210 is configured to receive the random data. An input of the first NAND gate 220 is connected to an output of the XOR gate 210, an input of the inverter 230 is connected to an output of the first NAND gate 220. An input of the second NAND gate 240 is connected to an output of the inverter 230, the other input (init) of the second NAND gate 240 is configured to receive the enable signal, and an output of the second NAND gate 240 is connected to the other input of the first NAND gate 220.

Though only one inverter 230 is illustrated, there should be no limitation.

In practice, the number of inverters 230 is an odd number (such as 1, 3, 5, 7 . . . etc), the inverters are coupled to one another in series for protection when it's more than 3. Those with ordinary skill in the art may flexibly configure the number of inverters 230 depending on the desired application.

The ring oscillators 200 may be controlled by one bit or combination of several bits of data and one bit of random bit (said random data) to dynamically change power consumption characteristics of the electronic device 100. “init” is an activating control so that the differential power analysis countermeasure circuit 130 turns off for power saving when the electronic device 100 doesn't need protection.

In FIG. 2, the ring oscillators 200 can essentially consist of less logic gates to reduce the occupied area and the power consumption of the differential power analysis countermeasure circuit 130 and to resist a differential power analysis attack. Though the circuitry of FIG. 2 has many advantages, it shouldn't be limited to the present invention. In practice, any suitable structure of ring oscillators may all be adapted to the differential power analysis countermeasure circuit 130. Those with ordinary skill in the art may flexibly configure the differential power analysis countermeasure circuit 130 depending on the desired application

In one embodiment, the random number generator 120 as shown in FIG. 1 essentially consists of ring oscillators. For example, the random number generator 120 may be a ring oscillator based random number generator. If the random number generator 120 and the differential power analysis countermeasure circuit 130 both essentially consist of ring oscillators, that will be beneficial to integration of manufacturing processes. Alternatively, in another embodiment, the random number generator 120 may adopt other random generating circuit or random generating mechanism. Those with ordinary skill in the art may flexibly configure the random number generator 120 depending on the desired application

In view of above, a method for resisting a differential power analysis attack comprises the following steps (Said steps of the embodiment, unless otherwise defined, can be modified to the suitable rank or even do at the same moment). About hardware of doing the steps has been disclosed to the above embodiments, so they won't be mentioned again.

First, an enable signal is generated when encrypting or decrypting a plurality of bits of data, random data are generated, and then a differential power analysis countermeasure circuit is activated by the enable signal, so that the differential power analysis countermeasure circuit operates according to the bits of data and the random data.

In addition, in the method, providing the enable signal is stopped when not encrypting or decrypting the bits of data so that the differential power analysis countermeasure circuit turns off.

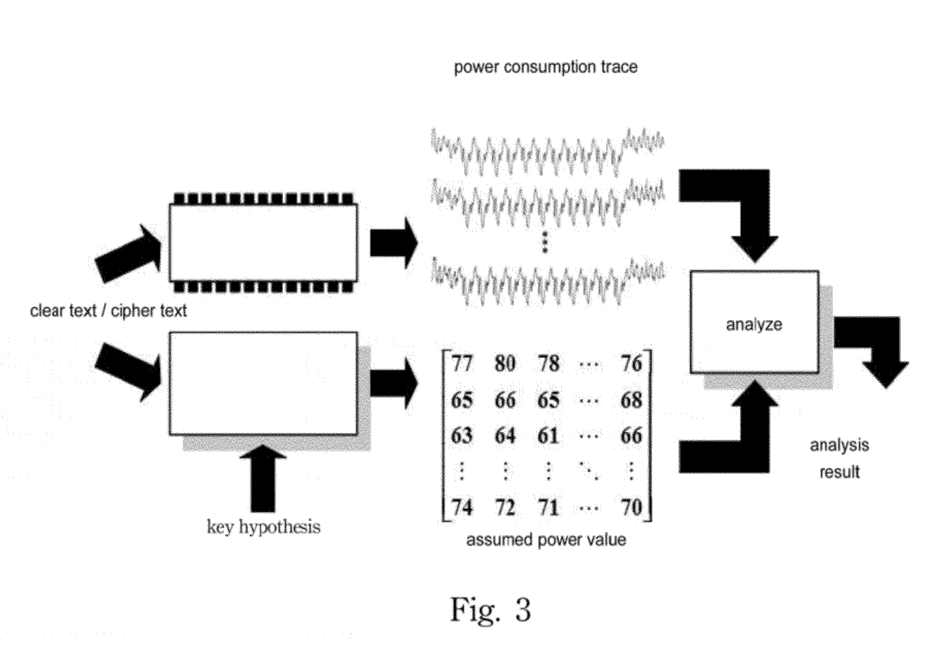

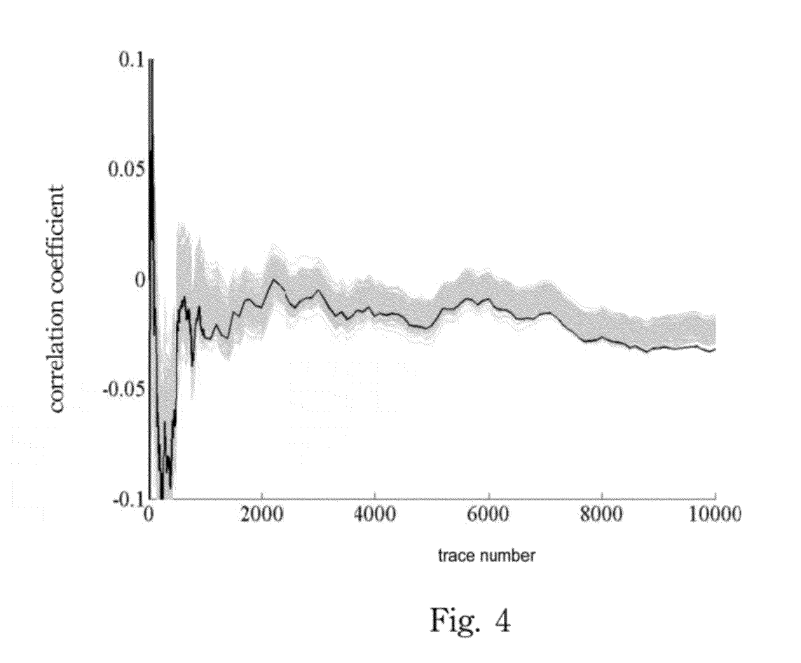

FIG. 3 is procedures of a differential power analysis attack of one embodiment of the present invention. The electronic device 100 is a cryptographic chip, after receiving plain/cipher texts of users, and the cryptographic chip starts encrypting/decrypting calculation according to the secret key of the chip. Attackers may build a power consumption model 300 according to the input plain/cipher texts and all possible keys to analyze and compromise keys. Taking AES encryption/decryption chip as an example, the analysis result is shown in FIG. 4, after about 9200 calculations, the correlation between the assumed power consumption model of the correct key and the power consumption of the chip is higher than other keys. Since the operation of the AES is byte oriented, 16 times different analysis may compromise a 128-bit key.

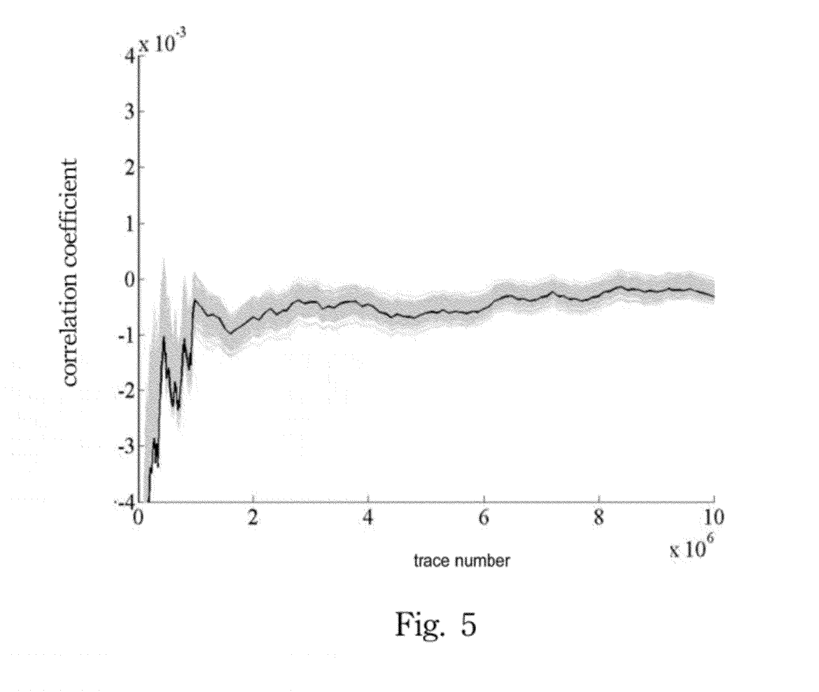

As shown in FIG. 5, it's the analysis result for a differential power analysis attack by the present invention. The correct key cannot be found even if at least 10,000,000 power traces are used.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An electronic device comprising:
an encryption/decryption unit for providing an enable signal when encrypting or decrypting a plurality of bits of data;
a random number generator electrically coupled to the encryption/decryption unit for generating random data; and
a differential power analysis countermeasure circuit electrically coupled to the random number generator and the encryption/decryption unit for operating according to the bits of data and the random data when receiving the enable signal.

2. The electronic device of claim 1, wherein the encryption/decryption unit stops providing the enable signal when not encrypting or decrypting the bits of data, so that the differential power analysis countermeasure circuit turns off.

3. The electronic device of claim 1, wherein the differential power analysis countermeasure circuit comprises:
a plurality of ring oscillators all for receiving the random data, wherein each of the ring oscillators receives one bit or a combination of several bits of data.

4. The electronic device of claim 3, wherein each of the ring oscillators comprises:
an XOR gate, wherein a first input of the XOR gate is configured to receive the one bit or the combination of several bits of data, and the other input of the XOR gate is configured to receive the random data;
a first NAND gate, wherein an input of the first NAND gate is connected to an output of the XOR gate;
at least one inverter, wherein an input of the at least one inverter is connected to an output of the first NAND gate;
a second NAND gate, wherein an input of the second NAND gate is connected to an output of the at least one inverter, the other input of the second NAND gate is configured to receive the enable signal, and an output of the second NAND gate is connected to the other input of the first NAND gate.

5. The electronic device of claim 4, wherein the number of the inverter is an odd number.

6. The electronic device of claim 1, further comprising:
a data register electrically coupled to the encryption/decryption unit; and
an input/output buffer electrically coupled to the data register.

7. The electronic device of claim 6, wherein the encryption/decryption unit, the random number generator, the differential power analysis countermeasure circuit, the input/output buffer and the data register are all integrated into a single chip.

8. The electronic device of claim 1, wherein the random number generator also use ring oscillators as random sources.

9. A method for resisting a differential power analysis attack comprising the steps of:
generating an enable signal when encrypting or decrypting a plurality of bits of data;
generating random data; and
activating a differential power analysis countermeasure circuit by the enable signal, so that the differential power analysis countermeasure circuit operates according to the bits of data and the random data.

10. The method of claim 9, further comprising:
stopping providing the enable signal when not encrypting or decrypting, so that the differential power analysis countermeasure circuit turns off.
